(19) United States
(12) Patent Application Publication
(10) Pub. No.: US 2026/0307677 A1
(43) Pub. Date: Oct. 8, 2026

(54) SYSTEM FOR DETECTING 3D OBJECT AND CORRECTING HEADING ANGLE BASED ON AI DEEP LEARNING FOR AUTONOMOUS DRIVING AND METHOD THEREOF

(71) Applicants: HYUNDAI MOTOR COMPANY, Seoul (KR); Kia Corporation, Seoul (KR)

(72) Inventor: Jun Hyung LEE, Hwaseong-si (KR)

(73) Assignees: HYUNDAI MOTOR COMPANY, Seoul (KR); Kia Corporation, Seoul (KR)

(21) Appl. No.: 19/349,671

(22) Filed: Oct. 3, 2025

(30) Foreign Application Priority Data
Mar. 25, 2025 (KR) 10-2025-0038200

(51) Int. Cl. B60W 60/00; G06V 10/70

(52) U.S. Cl. CPC B60W 60/0011; G06V 10/70

(57) ABSTRACT

In a system and method for recognizing an object through an AI module and an autonomous driving sensor and correcting a heading angle, the system includes a processor including an object recognition module, as part of the AI module, that recognizes an object existing in a surrounding environment from data input from the autonomous driving sensor, and a memory that stores point cloud data, wherein the AI module executes determining whether to correct the heading angle based on estimation of a kernel density, and correcting the heading angle for a P-Box predicted by the autonomous driving sensor and the AI module when it is determined that correction is necessary as a result of determining whether to correct the heading angle.

### CROSS-REFERENCE TO RELATED APPLICATION

This application claims the benefit of priority to Korean Patent Application No. 10-2025-0038200, filed in the Korean Intellectual Property Office on Mar. 25, 2025, the entire contents of which are incorporated herein by reference.

### TECHNICAL FIELD

The present disclosure relates to a 3D object detection and heading angle correction technology based on artificial intelligence (AI) deep learning for autonomous driving, and more particularly, to a system and method for predicting classification and shape information on an object existing in an environment around an autonomous vehicle by utilizing data obtained through sensors such as a camera, LiDAR, and radar as a deep learning network input.

### BACKGROUND

As autonomous vehicles are developed and commercialized, the number of cases using various sensors and artificial intelligence (AI) technologies to support the autonomous driving functions of vehicles has increased. For example, research is ongoing into what objects exist in front of a moving vehicle, what the distance is between the object and the vehicle, and what algorithms the vehicle should use to respond to specific situations to ensure safety.

Accordingly, vehicle sensor technology has been more advanced, and high-performance sensors such as a light detection and ranging (LiDAR) that recognizes the surrounding environment using laser beams, a radio detection and ranging (radar) that uses radio waves, a ultrasonic sensor, a fisheye camera capable of photographing 360-degree images, a multifocal lens, and a global positioning systems (GPS), and the like have been installed in a vehicle.

By aggregating measurement results obtained from multiple sensors as described above, it has been possible to implement a so-called super sensor vehicle. In autonomous driving (or self-driving), the concept of a super sensor refers to a technology that aims to recognize the surrounding environment more accurately by combining measurements from various sensors rather than relying on individual sensors for the convenience and safety of driving. With the addition of information and communications technology (ICT) and cloud technology, the sensors required for autonomous driving and the AI algorithms related to them have been more sophisticated than ever before, not only targeting a single vehicle, but also remotely accumulating data from numerous vehicle units (fleet of vehicles) and training AI servers and databases to increase the confidence of vehicle sensor determination.

Among these, the LiDAR sensor, which is used to recognize an external environment, emits a laser and measures the time taken for the laser to be reflected by surrounding objects and the laser intensity, thereby recognizing various objects on the road during autonomous driving.

Object recognition using LiDAR and AI algorithms is not perfect. Despite the advancement of LiDAR sensing performance and advancement of AI technology, the technical requirements for accurately recognizing objects still remain.

### SUMMARY

The present disclosure has been made to solve the above-mentioned problems occurring in the prior art while advantages achieved by the prior art are maintained intact.

The present disclosure relates to a 3D object detection technology based on artificial intelligence (AI) deep learning for autonomous driving. More specifically, an aspect of the present disclosure provides a system and method for predicting classification and shape information on objects existing in the environment around an autonomous vehicle by utilizing data acquired from sensors such as a camera, LiDAR, and radar as input to a deep learning network.

The technical problems to be solved by the present disclosure are not limited to the aforementioned problems, and any other technical problems not mentioned herein will be clearly understood from the following description by those skilled in the art to which the present disclosure pertains.

In order to solve all or at least part of the technical problems described above, embodiments of the present disclosure may be implemented in various aspects as follows.

According to one aspect of the present disclosure, a system for recognizing an object through an AI module and an autonomous driving sensor and correcting a heading angle includes a processor including an object recognition module, as part of the AI module, that recognizes an object existing in a surrounding environment from data input from the autonomous driving sensor, and a memory that stores point cloud data, wherein the AI module executes determining whether to correct the heading angle based on estimation of a kernel density, and correcting the heading angle for a P-Box predicted by the autonomous driving sensor and the AI module based on that the AI module concludes that correction of the heading angle is necessary as a result of determining whether to correct the heading angle.

According to an aspect of the present disclosure, the processor may further execute generating input data for estimating the kernel density based on the P-Box corresponding to local maxima by a non-maximum suppression (NMS) process based on a confidence threshold preset for the AI prediction confidence for the P-Box.

According to an aspect of the present disclosure, the processor may further execute repeating the determining of whether to correct the heading angle and the correcting of the heading angle until the number of outputs of the NMS process is processed;

According to an aspect of the present disclosure, the NMS process may be executed by calculating a maximum point as follows:

$${B}_{1} = {\{ {b}_{1}^{i} \vert {b}_{1}^{i} = [ {c}_{1}^{i} , {s}_{1}^{i} , {x}_{1}^{i} , {y}_{1}^{i} , {z}_{1}^{i} , {l}_{1}^{i} , {w}_{1}^{i} , {h}_{1}^{i} , {θ}_{1}^{i} ] \}}_{i = 1}^{H}$$

$${B}_{2} = {\{ {b}_{2}^{i} \vert {b}_{2}^{i} = [ {c}_{2}^{i} , {s}_{2}^{i} , {x}_{2}^{i} , {y}_{2}^{i} , {z}_{2}^{i} , {l}_{2}^{i} , {w}_{2}^{i} , {h}_{2}^{i} , {θ}_{2}^{i} ] \}}_{i = 1}^{N}$$

$${B}_{3} = {\{ {b}_{3}^{i} \vert {b}_{3}^{i} = [ {c}_{3}^{i} , {s}_{3}^{i} , {x}_{3}^{i} , {y}_{3}^{i} , {z}_{3}^{i} , {l}_{3}^{i} , {w}_{3}^{i} , {h}_{3}^{i} , {θ}_{3}^{i} ] \}}_{i = 1}^{K}$$

wherein B₃ represents the maximum point, bⁱ represents an i-th object P-Box in B₁ which is an output of a deep learning-based object recognition system, c represents a class ID (integer value), B₂ represents an N object P-Boxes of object candidates filtered by the confidence threshold, s represents a prediction score and has a real number where 0<s≤1, (x, y, z) represent a center point position of the object P-Box based on a width, a length and a height of real numbers, (l, w, h) are real numbers representing a width, a length, and a height of a P-Box hexahedron, respectively, and θ is a real number representing a yaw heading angle, and H, N, and K are integers representing a number of object prediction boxes.

According to an aspect of the present disclosure, the non-maximum suppression (NMS) process may include additionally outputting index information as follows:

$$M = {\{ {mask}^{i} \vert {mask}^{i} : index information eliminated in NMS process \}}_{i = 1}^{K}$$

According to an aspect of the present disclosure, an output result of the correcting of the heading angle may be obtained as follows:

$${\hat{B}}_{3} = {\{ {\hat{b}}_{3}^{i} \vert {\hat{b}}_{3}^{i} = [ {c}_{3}^{i} , {s}_{3}^{i} , {x}_{3}^{i} , {y}_{3}^{i} , {z}_{3}^{i} , {l}_{3}^{i} , {w}_{3}^{i} , {h}_{3}^{i} , {\hat{θ}}_{3}^{i} ] \}}_{i = 1}^{K}$$

wherein \hat{B}₃ represents the output result and \hat{θ} is a real number representing the yaw heading angle).

According to an aspect of the present disclosure, a kernel bandwidth applied to the determining of whether to correct the heading angle is obtained as follows:

$$Bandwidth = 1.06 \times \hat{σ} \times {n}^{- 0.2}$$

wherein Bandwidth represents the kernel bandwidth, \hat{σ} represents a standard deviation of a data sample set corresponding to a density estimation input, and n represents a number of sample set elements used for density estimation.

According to an aspect of the present disclosure, the determining of whether to correct the heading angle may include deriving a heading angle corresponding to a maximum likelihood after deriving a probability density function having the heading angle as a probability variable.

According to another aspect of the present disclosure, a method of recognizing an object through an AI module and an autonomous driving sensor and correcting a heading angle includes determining whether to correct the heading angle based on estimation of a kernel density, and correcting the heading angle for a P-Box predicted by the autonomous driving sensor and the AI module based on that the AI module concludes that correction of the heading angle is necessary as a result of determining whether to correct the heading angle.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an overall system for automatically recognizing an object and controlling a vehicle for the purpose of autonomous driving or the like according to an embodiment of the present disclosure;

FIG. 2 is a flowchart illustrating in more detail a post-processing process related to object recognition according to the present disclosure;

FIG. 3 is a diagram illustrating a first code sample exemplifying a non-maximum suppression (NMS) algorithm based on AI prediction confidence for an object P-Box according to the present disclosure;

FIG. 4 is a flowchart illustrating an algorithm for correcting the heading angle of an object-related P-Box according to an embodiment of the present disclosure;

FIG. 5 is a diagram illustrating a second code sample corresponding to an algorithm for correcting the heading angle of an object-related P-Box according to an embodiment of the present disclosure;

FIG. 6 is a diagram illustrating a process of querying heading angle information of boxes eliminated in an NMS process based on a local maxima criterion of a box set and adding heading angle samples to the set according to an embodiment of the present disclosure;

FIG. 7 is a diagram illustrating a third code sample corresponding to an algorithm for determining whether to correct a heading angle according to an embodiment of the present disclosure;

FIG. 8 is a diagram illustrating a process of comparing the maximum likelihood heading angle for a confidence section centered on the local maxima (i.e., maximum point) box heading angle in relation to lines 20 to 22 of the second sample code, and correcting the heading angle;

FIG. 9 is a diagram illustrating a process of correcting a long-distance area object box heading angle by an object recognition and heading angle correction system according to an embodiment of the present disclosure; and

FIG. 10 is a block diagram illustrating a computing system for autonomous vehicle control and object recognition operations according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is specified by the identical numeral even when they are displayed on other drawings. Further, in describing the embodiment of the present disclosure, a detailed description of the related known configuration or function will be omitted when it is determined that it interferes with the understanding of the embodiment of the present disclosure.

In addition, terms, such as first, second, A, B, (a), (b) or the like may be used herein when describing components of the present disclosure. The terms are provided only to distinguish the elements from other elements, and the essences, sequences, orders, and numbers of the elements are not limited by the terms. In addition, unless defined otherwise, all terms used herein, including technical or scientific terms, have the same meanings as those generally understood by those skilled in the art to which the present disclosure pertains. The terms defined in the generally used dictionaries should be construed as having the meanings that coincide with the meanings of the contexts of the related technologies, and should not be construed as ideal or excessively formal meanings unless clearly defined in the specification of the present disclosure. For example, in the present disclosure, an object has virtually the same meaning as an object, and the expressions “object” and “subject” are arbitrarily used interchangeably in the present disclosure.

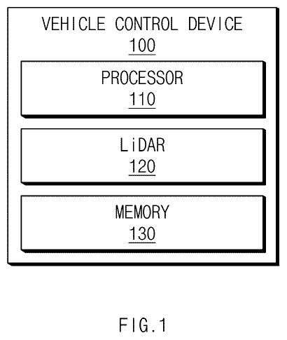

FIG. 1 is a block diagram illustrating an overall system for automatically recognizing an object and controlling a vehicle for the purpose of autonomous driving or the like according to an embodiment of the present disclosure.

Referring to FIG. 1, a vehicle control device 100 according to an exemplary embodiment of the present disclosure may be implemented inside or outside a vehicle, and some of the components included in the vehicle control device 100 may be implemented inside or outside the vehicle. In this case, the vehicle control device 100 may be formed integrally with the internal control units of the vehicle, or may be implemented as a separate device and connected to the control units of the vehicle by a separate connection means. For example, the vehicle control device 100 may further include components not shown in FIG. 1.

The vehicle control device 100 according to an exemplary embodiment of the present disclosure may include a processor 110, a Light Detection And Ranging (LiDAR) 120, and a memory 130. The processor 110, the LiDAR 120, or the memory 130 may be electronically and/or operably coupled with each other by an electronic component including a communication bus.

Hereinafter, hardware being operably coupled may mean that a direct connection or an indirect connection between the hardware is established wired or wirelessly, such that second hardware is controlled by first hardware among the hardware.

Although illustrated in different blocks, the embodiment is not limited thereto, and some of the hardware in FIG. 1 may be included in a single integrated circuit such as a system on chip (SoC). The type and/or number of hardware included in the vehicle control device 100 is not limited to that illustrated in FIG. 1. For example, the vehicle control device 100 may include only some of the hardware illustrated in FIG. 1.

The vehicle control device 100 according to an exemplary embodiment of the present disclosure may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), a graphic processing unit (GPU), and/or an application processor (AP). The processor 110 may have a single-core processor structure, or may have the structure of a multi-core processor including dual cores, quad cores, hexa cores, or octa cores.

According to an embodiment of the present disclosure, the processor 110 may include at least one of a graphic processing unit (GPU), a neural processing unit (NPU), or any combination thereof. For example, a GPU may be referred to as a visual processing unit (VPU). For example, an NPU may be referred to as a neural network processing unit.

The vehicle control device 100 according to an exemplary embodiment of the present disclosure may include a depth sensor for detecting an external object. For example, a depth sensor for detecting an external object may include at least one of a time-of-flight (ToF) sensor, the LiDAR 120, a structured light sensor, an ultrasonic sensor, an infrared sensor, a radio detection and ranging (radar), an optical distance sensor, or any combination thereof. Hereinafter, for convenience of explanation, the description will focus on the LiDAR.

The vehicle control device 100 according to an exemplary embodiment of the present disclosure may include the LiDAR 120 that obtains a plurality of points based on a pulse laser signal. For example, the LiDAR 120 may obtain data sets that identify objects surrounding the vehicle control device 100 (or a vehicle including the vehicle control device 100). For example, the LiDAR 120 may identify at least one of the position, direction of movement, speed, or any combination thereof of surrounding objects based on the pulse laser signal emitted from the LiDAR 120 being reflected back from surrounding objects.

For example, the LiDAR 120 may obtain data sets representing external objects in the space formed by the x-axis, y-axis, and z-axis based on pulse laser signals reflected from surrounding objects. For example, the LiDAR 120 may obtain data sets including a plurality of points in the space formed by the x-axis, the y-axis, and the z-axis based on receiving a pulse laser signal every specified time period. For example, the plurality of points may include points representing external objects within a three-dimensional virtual coordinate system. The 3D virtual coordinate system may include at least one of a vehicle coordinate system, a LiDAR coordinate system, or any combination thereof. However, examples of the 3D virtual coordinate system are not limited to those described above.

The memory 130 of the vehicle control device 100 according to an exemplary embodiment of the present disclosure may include a hardware component for storing data and/or instructions input and/or output to/from the processor 110. For example, the memory 130 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, a pseudo SRAM (PSRAM), or any combination thereof. For example, the non-volatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof.

In the memory 130 of the vehicle control device 100, one or more instructions (or commands) indicating calculation and/or operations to be performed by the processor 110 of the vehicle control device 100 with data may be stored. A set of one or more instructions may be referred to as a program, firmware, an operating system, a process, a routine, a sub-routine, and/or an application.

Hereinafter, the fact that an application is installed in the vehicle control device 100 may mean that one or more instructions provided in the form of an application are stored in the memory 130, and that one or more applications are stored in a format executable by the processor 110 of the vehicle control device 100 (e.g., a file having an extension specified by an operating system of the vehicle control device 100).

For example, the memory 130 may include a first neural network model for detecting an object. For example, the memory 130 may include a second neural network model for outputting the types of the plurality of points obtained by the LiDAR 120 and/or the scores of the plurality of points.

In an exemplary embodiment of the present disclosure, the processor 110 may obtain at least one of a first virtual box representing a target object, a first class representing a type of the target object, or a combination thereof, based on the plurality of points obtained through the LiDAR 120 and the first neural network model stored in the memory 130.

For example, the processor 110 may obtain at least one of a first virtual box representing a target object, a first class representing a type of the target object, or any combination thereof, based on inputting the plurality of points into the first neural network model. For example, the first neural network model may include an object detection model. For example, the target object may include an external object located within a specified distance from the vehicle control device 100 (or a host vehicle including the vehicle control device 100). For example, the target object may include an object that is identified by the vehicle control device 100 and is continuously tracked. For example, the type of a target object may include multiple types for classifying the target object. For example, the type of the target object may include at least one of a first type representing the ground, a second type representing a type different from the ground, or any combination thereof. However, the type of a target object is not limited to the above. For example, the type of a target object may include, at least one of a third type representing a person, a fourth type representing a vehicle, or any combination thereof, but is not limited thereto.

In an exemplary embodiment of the present disclosure, the processor 110 may obtain, based on the plurality of points and the second neural network model, at least one of first partial points corresponding to at least a part of the target object among the plurality of points, a second class identified through the first partial points and indicating the type of the target object, or any combination thereof. For example, the second neural network model may include a segmentation model.

For example, the second neural network model may include a neural network model for obtaining types of the plurality of points and scores of the plurality of points.

For example, the processor 110 may obtain first partial points corresponding to at least a portion of the target object among the plurality of points based on inputting the plurality of points into the second neural network model. For example, the processor 110 may identify the types of the plurality of points based on inputting the plurality of points into the second neural network model. For example, the processor 110 may obtain the first partial points corresponding to at least a portion of the target object from among the plurality of points based on the type of each of the plurality of points.

In an exemplary embodiment of the present disclosure, the processor 110 may perform a first specified algorithm for a plurality of points. For example, the processor 110 may perform the first specified algorithm for classifying a type of each of the plurality of points for a plurality of points. For example, the processor 110 may classify second partial points corresponding to a specified type among the plurality of points. For example, the specified type may include a type representing the ground.

For example, the processor 110 may classify the second partial points corresponding to a specified type based on performing the first specified algorithm on the plurality of points, and obtain (or identify) the first partial points by excluding the second partial points from among the plurality of points.

In an exemplary embodiment of the present disclosure, the processor 110 may obtain at least one of a partial class for obtaining a second class, a score of each of the plurality of points, or any combination thereof, based on inputting the plurality of points into the second neural network model. For example, the processor 110 may obtain a partial class and a score for each of the plurality of points based on inputting the plurality of points into the second neural network model. For example, the partial class may include a classification of each of the plurality of points into an arbitrary type.

For example, the processor 110 may fuse the partial class, the score of each of the plurality of points, and the second partial points. For example, the processor 110 may perform clustering based on the fusion of the partial class, the score of each of the plurality of points, and the second partial points. For example, clustering may include grouping the first partial points that correspond to at least part of a target object.

For example, the processor 110 may obtain a point cloud for generating a second virtual box based on the first partial points. For example, the processor 110 may obtain the point cloud based on grouping the first partial points.

For example, the processor 110 may generate a second virtual box for representing the target object, which is different from the first virtual box, based on the point cloud. For example, the second virtual box may include a box that includes at least some of the first partial points.

For example, the processor 110 may identify a heading direction indicating the moving direction of the target object based on at least one of the first partial points, the point cloud, or any combination thereof.

For example, the processor 110 may identify the position of the second virtual box in a virtual coordinate system based on at least one of the first partial points, the point cloud, or any combination thereof. For example, the processor 110 may identify the size of the second virtual box based on at least one of the first partial points, the point cloud, or any combination thereof. For example, the processor 110 may identify the second class based on at least one of the first partial points, the point cloud, or any combination thereof. For example, the processor 110 may identify at least one of the heading direction indicating the moving direction of a target object, the position of the second virtual box in the virtual coordinate system, the size of the second virtual box, the second class, or any combination thereof, based on at least one of the first partial points, the point cloud, or any combination thereof. For example, the processor 110 may identify the heading direction of the bounding box based on at least one of the first virtual box, the first class, the heading direction of the second virtual box, the position of the second virtual box, the size of the second virtual box, the second class, or any combination thereof. For example, the processor 110 may identify the position of the bounding box in the virtual coordinate system based on at least one of the first virtual box, the first class, the heading direction of the second virtual box, the position of the second virtual box, the size of the second virtual box, the second class, or any combination thereof. For example, the processor 110 may obtain a third class indicating the type of a target object corresponding to the bounding box based on at least one of the first virtual box, the first class, the heading direction of the second virtual box, the position of the second virtual box, the size of the second virtual box, the second class, or any combination thereof. For example, the processor 110 may obtain at least one of the heading direction of the bounding box, the position of the bounding box in the virtual coordinate system, the third class indicating the type of a target object corresponding to the bounding box, or any combination thereof, based on at least one of the first virtual box, the first class, the heading direction of the second virtual box, the position of the second virtual box, the size of the second virtual box, the second class, or any combination thereof.

For example, the processor 110 may assign a first identifier for tracking the second virtual box to the second virtual box. For example, the processor 110 may assign a second identifier corresponding to the first identifier to the bounding box.

For example, the processor 110 may track the bounding box by using the second identifier. For example, the processor 110 may track a target object based on identifying a plurality of bounding boxes including the bounding box to which the second identifier is assigned, in a plurality of frames. For example, because the second identifier is an identifier assigned to the bounding box corresponding to the target object, the processor 110 may track the target object by identifying the plurality of bounding boxes to which the second identifier is assigned, in the plurality of frames.

In an exemplary embodiment of the present disclosure, the processor 110 may output the bounding box corresponding to the target object based on at least one of the first virtual box, the first class, the first partial points, the second class, or any combination thereof. For example, the bounding box may include an example of a target object represented in the virtual coordinate system in the form of a hexahedron.

Hereinafter, operations performed by a CPU, a GPU, and/or an NPU included in the processor 110 will be briefly described.

In an exemplary embodiment of the present disclosure, the processor 110 may include at least one of a CPU, a GPU, an NPU, or any combination thereof. For example, at least one of the GPU, the NPU, or any combination thereof may obtain the first virtual box and the first class based on the first neural network model. For example, at least one of the GPU and the NPU may obtain the first virtual box and the first class. For example, at least one of the GPU, the NPU, or any combination thereof may obtain the partial class for obtaining the second class and the score for each of the plurality of points based on the second neural network model. For example, at least one of the GPU and the NPU may obtain the partial class for obtaining the second class and the score for each of the plurality of points based on the second neural network model. For example, the CPU may classify second partial points among the plurality of points that correspond to a specified type, based on performing the first specified algorithm for classifying the type of each of the plurality of points for the plurality of points.

As described above, the vehicle control device 100 according to an exemplary embodiment of the present disclosure may include at least one processor 110. The vehicle control device 100 may accurately detect a target object by detecting the target object using at least one processor 110. In addition, by performing parallel processes, the vehicle control device 100 may reduce the load on each processor.

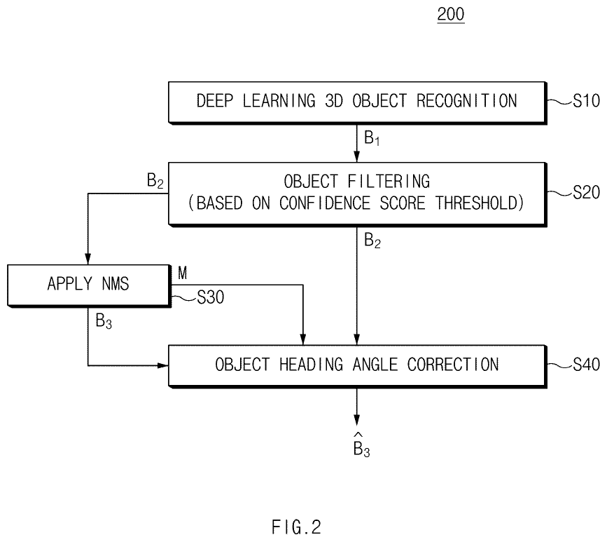

Meanwhile, before describing FIG. 2, for a general understanding of AI object recognition according to the present disclosure, a description related to LiDAR-based object recognition is added as follows.

The object recognition process by LiDAR 120 and AI module includes three operations: preprocessing, segmentation, and tracking.

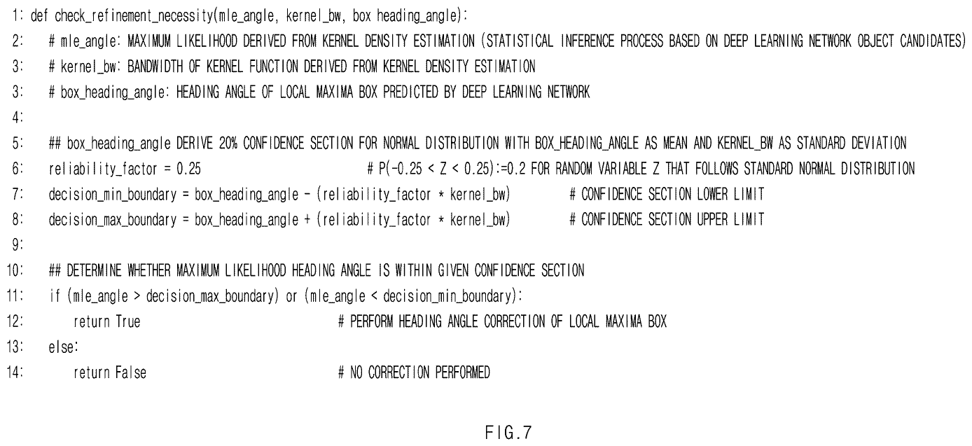

An object recognition system 1000 (see FIG. 7) according to the present disclosure performs a pre-processing process before executing an object recognition function. The preprocessing may include, for example, an operation of removing points forming the ground based on laser sensing data (i.e., unprocessed raw data) input from LiDAR 120. Because the laser beam reflected from the ground may be mistakenly recognized as an object on the ground, the process of distinguishing between the ground and non-ground is performed in a preprocessing operation, and when necessary, may also be performed in a segmentation operation.

In short, in AI object recognition, preprocessing may be understood as a process in which an image processing tool of an AI module in the processor 110 removes noise from a LiDAR point cloud image and reduces the total number of points existing in the LiDAR point cloud image through, for example, a voxel down-sampling technique to improve computational efficiency.

For reference, the LiDAR point cloud image may also be displayed in a bird's eye view (BEV) manner. When a LiDAR map is created as if it were a bird's eye view of the city while flying in the sky, it is called a BEV image.

That is, as described above, the LiDAR 120 transmits a laser beam into a surrounding environment and records the time when the laser beam is reflected by an external object and returns, thereby generating a dot (i.e., a point) for each of numerous laser signals and calculating the distance to the point. By repeatedly transmitting a large number of laser beams in such a manner, the processor 110 may generate a real-time LiDAR map of the surrounding environment as a BEV type three-dimensional map, and as a two-dimensional map when necessary.

The lines or surfaces that appear in black and white on the LiDAR point cloud map are actually composed of countless points (each of which is generated by a laser beam of the LiDAR 120), and for this reason, the LiDAR sensing image is also called a LiDAR point cloud image. Of course, for example, by combining a red-green-blue-depth (RGB-D) sensor with a LiDAR sensor, the LiDAR point cloud image may be reconstructed in color.

Although it is difficult for humans to recognize objects with just one point in a LiDAR point cloud image, when we look at the point cloud comprehensively, such as from a BEV perspective or a two-dimensional plan, we may roughly guess what the surroundings of the vehicle currently driving autonomously look like. Furthermore, it is possible to recognize, for example, vehicles, buses, pedestrians, street trees, traffic signs, etc. existing in a LiDAR point cloud image. In AI image recognition technology, things or people may be called objects, and each object may be classified into a class that belongs to a group with specific characteristics, such as a vehicle class, a bus class, and the like.

In order to classify objects within a LiDAR point cloud image into car and bus classes, the help of a deep AI neural network is needed. In order to find objects in a LiDAR point cloud image and identify the classes of those objects using an AI neural network, AI training may be performed first.

For example, a dataset called PANDASET™ (source: https://pandaset.org/#data-collection) includes over 48,000 camera images (mostly taken in the Silicon Valley area in the United States) and over 16,000 LiDAR scan images, which are annotated with 28 classes in total, including pedestrians, vehicles, bicycles, construction site signs, traffic signs, and the like.

In addition, a LiDAR point cloud image may be visualized to suit the user's desired options by using a point cloud processing tool such as Open3D™ (source: https://www.open3d.org/). Because the LiDAR 120 is capable of distance detection, a 3D LiDAR image may be reproduced more realistically, for example, by displaying distant objects in dark blue and nearby objects in light blue during visual processing with Open3D™.

In addition, as described above, the original LiDAR image (i.e., raw data) may be preprocessed, for example, by applying a technique called voxel (3D pixel) down-sampling to the LiDAR point cloud image. In this case, a voxel refers to a 3D pixel in the shape of a cube, and voxel down-sampling is a technology that reduces the number of points so as not to require excessive AI calculations while maintaining the structure of various objects included in a LiDAR point cloud.

Meanwhile, the LiDAR 120 emits, for example, ‘m’ laser beams ‘n’ times during one scan cycle, and in this case, the scan values of the laser beams that return after colliding with an external object constitute an (m×n) matrix, and (m×n) matrix data is called a range image. Each point that constitutes a LiDAR point cloud image includes depth (i.e. range) information, as well as the intensity, azimuth, inclination, and other additional information of the returned laser pulse. For a range image, AI learning is possible with large datasets such as Waymo™ open dataset (WOD).

Range view (RV) is a technique that converts a 3D point cloud into a 2D or 2.5D scene, and expresses it as a LiDAR 3D map that humans intuitively understand, like an analog picture, instead of a large number of points. In a range view image, a 3D LiDAR point cloud image has 2D coordinates, but the 3D laser-related information (angle, inclination, intensity, etc.) recorded when obtaining the range image is not discarded. By applying a variable called a width to (x, y) coordinates among the (x, y, z) coordinate values of a 3D LiDAR image, the coordinate of one 2D axis is obtained, and by applying a variable called a height and range image information representing the range (depth) to the (z) coordinate, the coordinate of another 2D axis is obtained, which creates a 2D range view image.

In addition, an AI algorithm according to the present disclosure may include a convolutional neural network (CNN), which is an AI training module frequently used to extract features (or feature points) from image data. To this end, there are commercially available datasets including tens of thousands of images, and currently, there are CNN versions capable of processing images from one dimension to three dimensions. That is, the results of the range view image processing tool are used to train a CNN neural network and perform the function of helping AI accurately recognize objects in an image.

Because objects existing around an autonomous vehicle are ultimately recognized by a machine, an operation of generating a ground truth (GT) bounding box on the LiDAR map described above is also an important process in object recognition. In machine learning, ground truth (GT) is a term used to indicate an original or actual value of data that an AI is to learn. It may be understood as a type of image annotation applied to a LiDAR point cloud image, usually as a bounding box with a box-shaped boundary.

That is, in order to recognize objects, the AI module brings labels and groups various objects. Of course, the spacing of the 3D data points used to output the GT bounding box may be set to allow about 50 and 1000 LiDAR cloud points to be contained in one GT bounding box.

Of course, such GT annotations do not exist in the raw data captured by sensors such as LiDAR 120 and the like while the vehicle drives. The processor 110 recognize objects belonging to various classes, such as road signs, crosswalks, pedestrians, other vehicles, and center lanes, as objects. GT annotation is a means used to measure an object recognition error and sometimes evaluate AI performance by comparing object determination results recognized by the AI algorithm of the processor 110 with reality. The GT bounding box, which is applied to the original image in the form of annotations, may be set manually by the user, but there are also commercially available GT calculation tools, such as Grid-striding.

Meanwhile, when driving the AI object recognition module, it is also possible to check the predicted bounding box. The result recognized by the processor 110 as an object of a specific class from the original image data obtained from the LiDAR sensor 120, and the like, appears in the form of another bounding box similar to the GT bounding box. Unlike GT bounding boxes, predicted bounding boxes are the result of computations by the autonomous driving AI. The predicted bounding box may coincide with the GT bounding box, but the predicted bounding box may not coincide with the GT bounding box or may not overlap with the GT bounding box at all.

For reference, because it is difficult to definitively determine that a specific class of object actually exists at a location based on predicted bounding boxes alone, the predicted bounding boxes are usually called probability boxes (P-Boxes).

Segmentation processing performed after preprocessing refers to, for example, displaying a specific part of a road (e.g., a traffic light) in red and the other parts (asphalt road) in blue. Clustering point clouds into specified groups and generating P-Boxes may also be performed at the segmentation operation. For reference, there is also a technology called cluster expansion, where the expansion target includes the cluster to all points within the distance between the seed point and epsilon (the minimum distance that constitutes the cluster).

Clustering and P-box generation based on a point cloud are performed during segmentation processing. In short, an AI network performing segmentation is used to obtain point labels from the LiDAR sensor 120.

In order to solve the problem of ground recognition errors occurring during segmentation, the present disclosure proposes a “rule-based” ground recognition and label fusion technique. Such a road surface recognition algorithm may apply any of a variety of techniques, including slope-based road surface recognition, grid-based road surface recognition, and other non-planar-based road surface recognition. However, the present disclosure proposes to adopt a slope-based road surface recognition technique when recognizing the road surface inside a tunnel.

For reference, semantic segmentation is the task of attaching a unique class label to each point in the point cloud generated by the LiDAR 120. In LiDAR image processing technology, semantic segmentation is a technology that finds and uses meaningful information from LiDAR data for object recognition and scene reproduction required for implementing autonomous driving. Various semantic segmentation AI models already exist, such as a projection-based method, a point-based method, a sparse convolution-based method, and the like. For example, the semantic segmentation result may be the result of an AI operation performed by the processor 110 with the NVIDIA DRIVE™ AGX system, and through such a configuration, for example, various colors may be added to a LiDAR point cloud image. After the segmentation process as above, LiDAR images are treated through a process called post-processing.

After the segmentation process as above, LiDAR images are treated through a process called post-processing. The post-processing refers to converting point cloud data into 3D maps or modeling, which are meaningful information for autonomous driving. The post-processing also includes the process of finally removing noise and errors from LiDAR point cloud images, recognizing objects such as vehicles or pedestrians from the point cloud, and, if necessary, attaching a unique identifier to the point cloud information to register it.

The present disclosure relates mainly to a post-processing process among 3D object detection technologies based on AI deep learning for autonomous driving. That is, according to an exemplary embodiment of the present disclosure, the data obtained through sensors such as a camera, the LiDAR 120, a radar, and the like are used as input to a deep learning network to predict classification and shape information about an object existing in the environment around an autonomous vehicle. In this case, the object classification information includes the object class classification result described above and AI prediction confidence score information, and the object shape information includes a center point position of an object, a P-Box including a corresponding object, and heading angle information.

In a post-processing operation of the object recognition process according to an exemplary embodiment of the present disclosure a non-maximum suppression (NMS) algorithm may be applied, which is an algorithm that derives a box corresponding to “local maxima” for a point cluster of a predicted bounding box output from an object recognition network. In this case, “Local Maxima” refers to the P-Box with the highest object detection accuracy among the predicted bounding boxes generated centered on a specific object. That is, the P-Box most accurately predicted by AI for each object becomes the “local maxima”.

FIG. 2 is a flowchart illustrating in more detail a post-processing process related to object recognition according to an exemplary embodiment of the present disclosure. According to an exemplary embodiment of the present disclosure, the post-processing NMS algorithm selects a predicted bounding box (i.e., P-Box) with a high AI prediction confidence score as local maxima.

The sensor data input to the system 1000 includes various sensor data for autonomous driving, such as RGB images, LiDAR 120 point clouds, and the like. In addition, a deep learning-based 3D object recognition system according to an exemplary embodiment of the present disclosure includes an artificial neural network for object detection.

That is, according to an exemplary embodiment of the present disclosure, the sensor data is received as input, passed through an artificial neural network, and then post-processing is executed on the P-Box predicted by AI. As illustrated in FIG. 2, output B₁ of the deep learning-based object recognition system executed in operation S10 is received as input in operation S20 (see Equation 1 below), and object class classification information and 3D box shape information are output as \hat{B}₃ (see Equation 5 below) in operation S40.

The system output according to an exemplary embodiment of the present disclosure is sensor data-based object class classification information and 3D P-Box shape information for the system detection area. In the post-processing system according to an exemplary embodiment of the present disclosure, after first outputting B₁ which is the output of the deep learning-based 3D object recognition system in operation S10, regardless of the object box prediction scheme according to the deep learning system, all arbitrary black box model outputs B₁ may be unifiedly expressed in the form of H object box candidates. In addition, a technique called object confidence score thresholding is proposed, which is a process (i.e., operation S20) of excluding P-Box candidates below a confidence score based on a predefined confidence score. The algorithm output in operation S20, which is filtering object candidate information B₂ (N object boxes), is calculated according to following Equation 2.

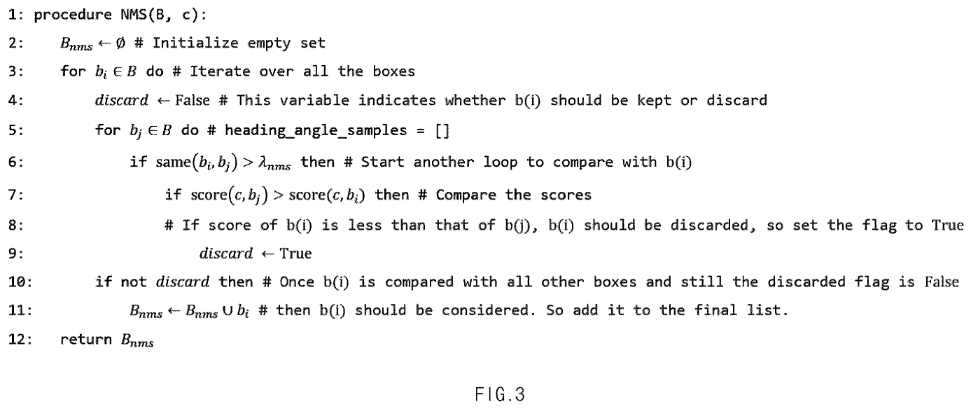

The non-maximum suppression (NMS) algorithm illustrated in operation S30 of FIG. 2 is a technology for eliminating object boxes by reflecting a predefined intersection-of-union (IoU, which refers to the proportion of the overlapping area of the GT bounding box and the P-Box for an object to the entire area) threshold after sorting them in descending order based on the confidence score of each object box, and is implemented as an example, such as the first code sample illustrated in FIG. 3.

That is, FIG. 3 is a diagram illustrating a first code sample exemplifying a non-maximum suppression (NMS) algorithm based on AI prediction confidence for an object P-Box according to an exemplary embodiment of the present disclosure, which corresponds to operation S30 of FIG. 2.

Specifically looking at the NMS algorithm illustrated in FIGS. 2 and 3, after the execution of the NMS process of operation S30, set B₃ of K object boxes (see Equation 3) remaining are first obtained, and then index information M of the surrounding boxes eliminated for each object box (i.e., additional derivation information for the present disclosure, see Equation 4) is obtained. The surrounding object box indexes that are eliminated during the NMS execution process are stored and used by the heading angle correction system in operation S40.

The object box heading angle correction process of operation S40 according to an exemplary embodiment of the present disclosure performs correction for each of the K object boxes derived from the NMS process of operation S30, determines whether to correct the heading angle through a statistical inference algorithm, and derives a correction value. In this case, the system output at operation S40 is final object box candidate group \hat{B}₃ (see Equation 5) that passes through the heading angle correction system, and ultimately, the output of the post-processing system 200 illustrated in FIG. 2 becomes object box heading angle correction system output \hat{B}₃.

$${B}_{1} = {\{ {b}_{1}^{i} \vert {b}_{1}^{i} = [ {c}_{1}^{i} , {s}_{1}^{i} , {x}_{1}^{i} , {y}_{1}^{i} , {z}_{1}^{i} , {l}_{1}^{i} , {w}_{1}^{i} , {h}_{1}^{i} , {θ}_{1}^{i} ] \}}_{i = 1}^{H} , \\ ( {b}^{i} represents an i - th object in P - Box in {B}_{1} ) \qquad [ Equation 1 ]$$

$${B}_{2} = {\{ {b}_{2}^{i} \vert {b}_{2}^{i} = [ {c}_{2}^{i} , {s}_{2}^{i} , {x}_{2}^{i} , {y}_{2}^{i} , {z}_{2}^{i} , {l}_{2}^{i} , {w}_{2}^{i} , {h}_{2}^{i} , {θ}_{2}^{i} ] \}}_{i = 1}^{N} \qquad [ Equation 2 ]$$

$${B}_{3} = {\{ {b}_{3}^{i} \vert {b}_{3}^{i} = [ {c}_{3}^{i} , {s}_{3}^{i} , {x}_{3}^{i} , {y}_{3}^{i} , {z}_{3}^{i} , {l}_{3}^{i} , {w}_{3}^{i} , {h}_{3}^{i} , {θ}_{3}^{i} ] \}}_{i = 1}^{K} \qquad [ Equation 3 ]$$

$$M = {\{ {mask}^{i} \vert {mask}^{i} : \\ index information eliminated in NMS process \}}_{i = 1}^{K} \qquad [ Equation 4 ]$$

$${\hat{B}}_{3} = {\{ {\hat{b}}_{3}^{i} \vert {\hat{b}}_{3}^{i} = [ {c}_{3}^{i} , {s}_{3}^{i} , {x}_{3}^{i} , {y}_{3}^{i} , {z}_{3}^{i} , {l}_{3}^{i} , {w}_{3}^{i} , {h}_{3}^{i} , {\hat{θ}}_{3}^{i} ] \}}_{i = 1}^{K} \qquad [ Equation 5 ]$$

For reference, in Equation 1 to Equation 5, c is a class ID (integer value), and s is a confidence score (prediction score) and a real number where 0<s≤1. (x, y, z) represent the center point position of the object P-Box based on a width, a length and a height of real numbers, and (l, w, h) are real numbers representing a width, a length, and a height of a P-Box hexahedron, respectively. In addition, (θ, \hat{θ}) is a real number representing a yaw heading angle, and H, N, and K are integers representing a number of object prediction boxes.

To summarize, in the object heading angle correction algorithm 200 (particularly operation S40) according to an exemplary embodiment of the present disclosure, first, an input is made to the heading angle correction system, which is input as object box set B₂ (see FIG. 2). Object box set B₃ is a set of “local maxima” boxes derived after performing NMS based on the IoU threshold. In box index information M that is eliminated during the NMS execution process, the box index information eliminated during NMS execution is stored for each local maxima box element of set B₃. In operation S40, the output of the heading angle correction system (i.e., final object box candidate set \hat{B}₃) is a set of boxes in which the heading angles of each object box are corrected, and the heading angle information of each box element is changed to the corrected value.

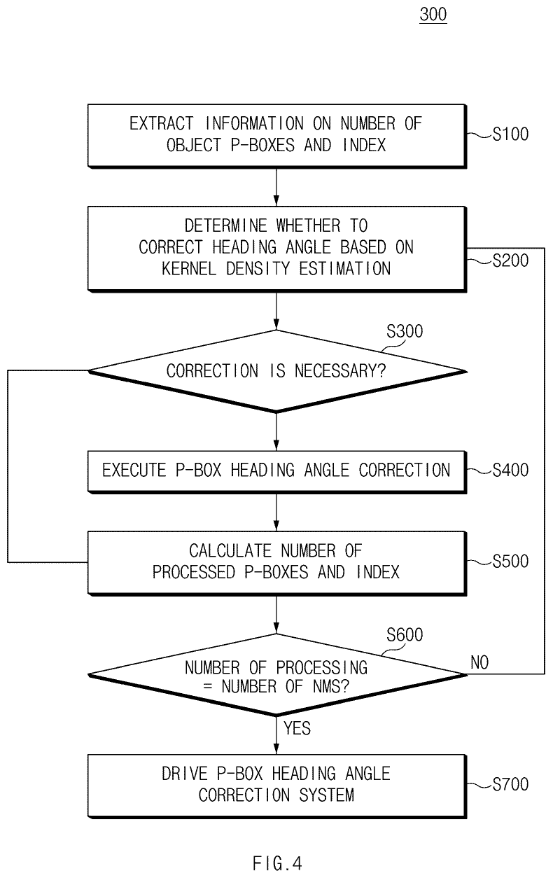

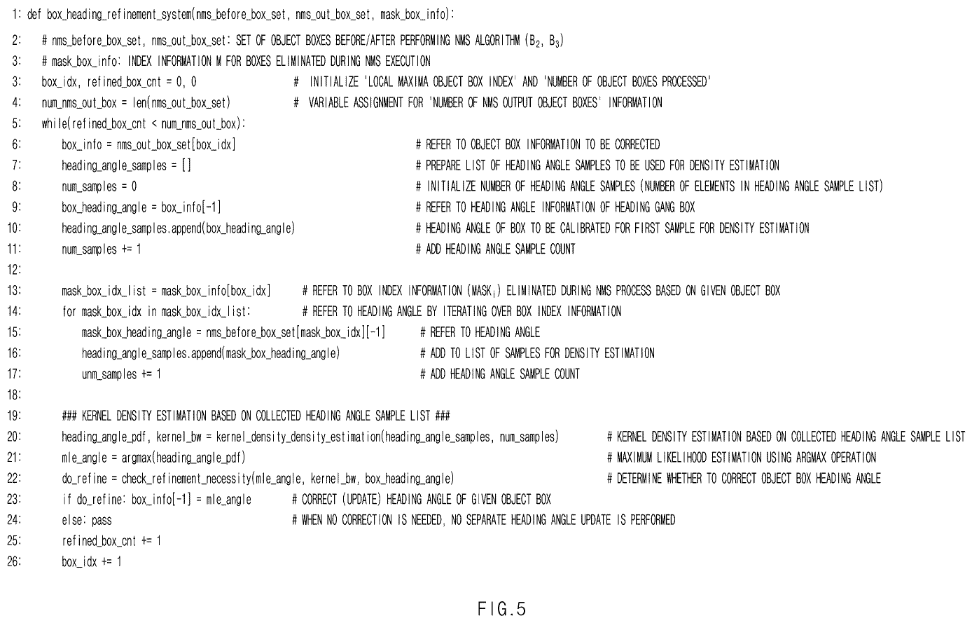

FIG. 4 is a flowchart illustrating an algorithm 300 for correcting the heading angle of an object-related P-Box according to an embodiment of the present disclosure. FIG. 5 is a diagram illustrating a second code sample corresponding to the algorithm 300 for correcting the heading angle of an object-related P-Box according to an embodiment of the present disclosure. The second code sample illustrated in FIG. 5 includes code lines from number 1 to number 26.

The core design element of the algorithm for correcting a heading angle according to an exemplary embodiment of the present disclosure is a kernel function, which refers to the form of a kernel function to be used for kernel density estimation. The kernel function receives two input vectors and calculates the similarity or inner product between the two vectors.

For reference, according to an exemplary embodiment of the present disclosure, a kernel function in the form of a Gaussian normal distribution may be used, and because the heading angle of the object has a period of 360° (2π), the design criterion requires the form of a kernel function that is continuous and differentiable over the entire real number. The deep learning network of the AI module installed in the processor 110 learns the heading angle prediction for an arbitrary object based on a regression model (which is a mathematical model that outputs continuous prediction values using given data in statistics). In this case, a likelihood function is assumed to be a Gaussian distribution, so the kernel function used in the present disclosure also utilizes a Gaussian distribution. In this case, in statistics, likelihood is a value that indicates the degree to which the parameters of a probability distribution are consistent with the sample values of a random variable. In detail, the likelihood of a parameter for a given sample value is the probability that a distribution that follows the parameter gives to a given observation. The likelihood function may not be a probability distribution, and may not add up to 1.

According to the exemplary embodiments of the present disclosure, it is considered as a Gaussian distribution that takes the object P-Box heading angle as the average, and the kernel function bandwidth is a factor that determines the smoothness of the kernel function to be used for density estimation. According to the exemplary embodiments of the present disclosure, a bandwidth determination scheme that considers the distribution of input data used for density estimation is used as following Equation 6.

$$Bandwidth = 1.06 \times \hat{σ} \times {n}^{- 0.2} \qquad [ Equation 6 ]$$

Where \hat{σ} is the standard deviation of the data sample set corresponding to the density estimation input, and n is the number of sample set elements used for density estimation. The design criterion is to perform adaptive statistical estimation by considering the heading angle distribution of boxes around local maxima.

Looking at the algorithm 300 for correcting an object box heading angle according to an exemplary embodiment of the present disclosure illustrated in FIGS. 4 and 5, first, in operation S100, the number of P-Boxes related to an object and related index information are extracted.

As an operation for performing heading angle correction for each individual box (local maxima) within a final object box set, an algorithm for determining whether to perform heading angle correction (i.e., operation S200 of FIG. 4, corresponding to the third code sample of FIG. 7 described below) performs statistical inference based on kernel density estimation for a heading angle sample set to determine the necessity of correction for the corresponding local maxima box in operation S300.

Continuing in operation S200, the kernel bandwidth is derived and the density is estimated based on the list of collected heading angle samples. This corresponds to line 20 of the second code sample in FIG. 5. When calculating the kernel function bandwidth to be used for kernel density estimation, the “kernel function bandwidth” is referred to as a design element of the heading angle correction system, a probability density function having the heading angle as a probability variable is derived, and heading angle

$$Bandwidth = 1.06 \times \hat{σ} \times {n}^{- 0.2} \qquad [ Equation 6 ]$$

corresponding to the maximum likelihood is derived. This corresponds to line 21 of the second code sample.

The heading angle correction algorithm of the present disclosure according to operation S400 is performed when a YES decision is made after determining whether to perform correction in operation S200 or operation S300. Looking at operation S400 in detail, first, it is determined whether to perform heading angle correction based on kernel density estimation. The local maxima box heading angle and the heading angles of surrounding boxes eliminated based on the box in the NMS process are added to the density estimation sample list. The programming code implementing it may be referred to, for example, lines 7 to 17 of the second code sample illustrated in FIG. 5.

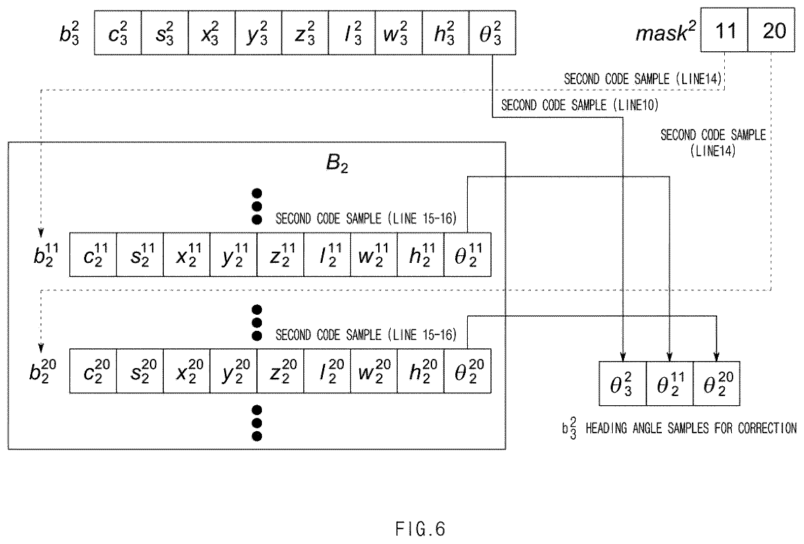

The following description refers to FIG. 6. FIG. 6 is a diagram illustrating a process of querying heading angle information of boxes eliminated in an NMS process based on a local maxima criterion of a box set and adding heading angle samples to the set according to an embodiment of the present disclosure.

Referring to FIG. 6, for example, the index information of the surrounding object boxes eliminated based on the i-th object box

$${b}_{3}^{i}$$

of B₃ contained in muskⁱ, so it is possible to reference heading angle information by utilizing it. The process of retrieving the heading angle information of boxes

$${b}_{2}^{11} and {b}_{2}^{20}$$

(the 11-in and 20-th boxes of box set B₃) eliminated in the NMS process based on the second local maxima box

$${\hat{θ}}_{3}^{1}$$

of box set B₃, and adding it to the heading angle sample set is performed.

Meanwhile, in operation S300, when determining whether to correct the heading angle based on estimation of a kernel density, it is determined whether to correct to the heading angle based on the result of the maximum likelihood-based heading angle estimation. It is checked whether the result of the maximum likelihood-based heading angle estimation meets a confidence level of, for example, about 20% of the heading angle center of the local maxima box, and the confidence interval is derived using a normal distribution whose mean corresponds to the heading angle of the local maxima box, with the kernel bandwidth used in kernel density estimation as the standard deviation.

When the maximum likelihood heading angle is out of the confidence section, the need for heading angle correction corresponds to 80% confidence level, so that correction is performed. When a NO decision is made in operation S300, the value derived in operation S30 may be used as is without performing a separate correction. This may be seen by referring to line 22 of the second code sample in FIG. 5 and the third code sample in FIG. 7.

For reference, FIG. 7 is a diagram illustrating a third code sample corresponding to an algorithm (i.e., operation S200) for determining whether to correct a heading angle according to an embodiment of the present disclosure.

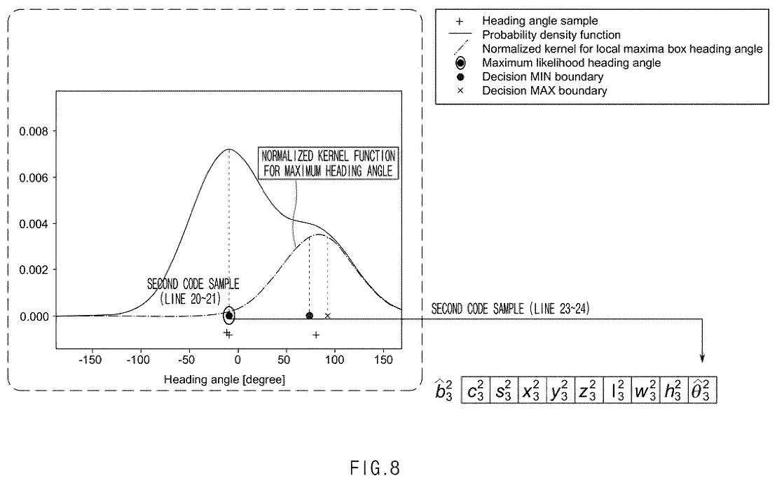

In addition, FIG. 8 is a diagram illustrating a process of comparing the maximum likelihood heading angle for a confidence section centered on the local maxima (i.e., maximum point) box heading angle in relation to lines 20 to 22 of the second sample code, and correcting the heading angle.

Again, in the object box heading angle correction in operation S400, the heading angle of the local maxima box is corrected

$$( i . e . , {θ}_{3}^{i} \to {\hat{θ}}_{3}^{i} ) ,$$

and when it is determined that correction is necessary, the heading angle of the local maxima box is updated as the maximum likelihood heading angle. This corresponds to lines 23 to 24 of the second code sample in FIG. 5.

A 3D object recognition artificial neural network system, to which a heading angle correction technique based on kernel density estimation is applied, includes a post-processing system (i.e., confidence threshold-based filtering, NMS) for deriving object box candidates as the system 1000 that performs 3D box shape and object class classification in 3D space for LiDAR point cloud data input. In this case, the input is 3D point cloud data, and the output is an object box set after performing NMS (output of a conventional technology system), which includes an object box set before performing NMS and information on the index of an eliminated box generated during the NMS process.

The object box yaw heading angle correction system, which is a system for correcting a yaw heading angle of a 3D object box according to an exemplary embodiment of the present disclosure, has an output of a 3D object recognition artificial neural network system as the input and as the output, an object box set after performing NMS with the yaw heading angle corrected.

The operations S200 to S500 described above are performed until all the processes equal to the number of NMS are completed in operation S600, and the P-Box heading angle correction system is driven in operation S700.

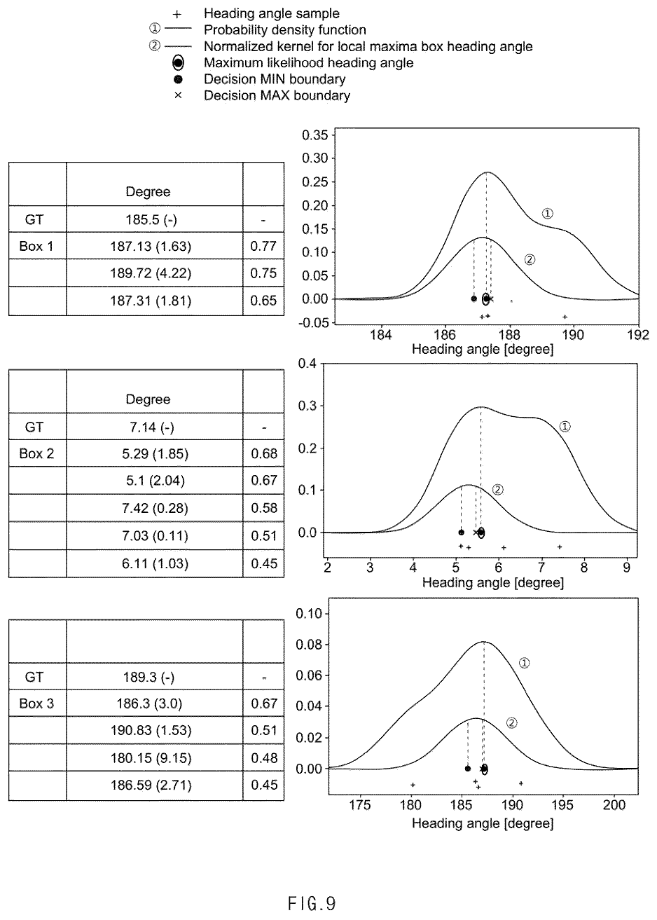

FIG. 9 is a diagram illustrating a process of correcting a long-distance area object box heading angle by an object recognition and heading angle correction system according to an embodiment of the present disclosure. FIG. 9 illustrates the actual experimental results, which will allow a clear understanding of the heading correction performance of the present disclosure based on the descriptions in FIGS. 2 to 8.

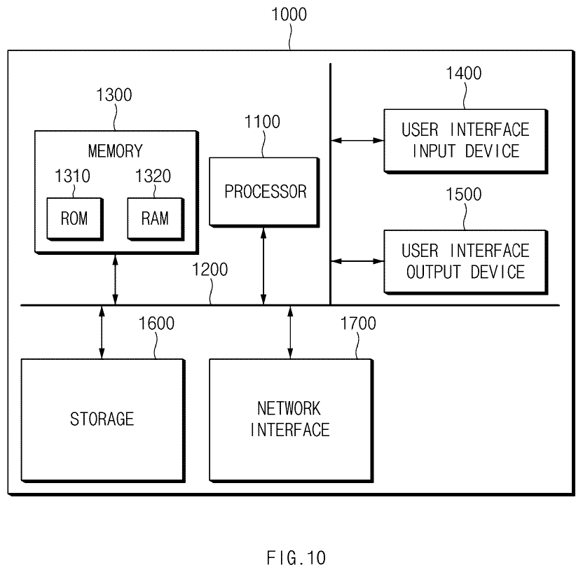

FIG. 10 is a block diagram illustrating a computing system 1000 for autonomous vehicle control and object recognition operations according to an embodiment of the present disclosure.

Referring to FIG. 10, the computing system 1000 may include at least one processor 1100, a memory 1300, a user interface input device 1400, a user interface output device 1500, storage 1600, and a network interface 1700 connected through a bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) and a random access memory (RAM).

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM memory, a flash memory, a ROM memory, an EPROM memory, an EEPROM memory, a register, a hard disk, solid state drive (SSD), a detachable disk, or a CD-ROM.

The exemplary storage medium is coupled to the processor 1100, and the processor 1100 may read information from the storage medium and may write information in the storage medium. In another method, the storage medium may be integrated with the processor. The processor and the storage medium may reside in an application specific integrated circuit (ASIC). The ASIC may reside in a user terminal. In another method, the processor and the storage medium may reside in the user terminal as an individual component.

The present disclosure relates to a system and method for recognizing an object through an AI module and an autonomous driving sensor and correcting a heading angle, and includes determining whether to correct the heading angle based on estimation of a kernel density by the AI module, and correcting the heading angle for a P-Box predicted by the autonomous driving sensor and AI module when it is determined that correction is necessary as a result of determining whether to correct the heading angle as the core of the present disclosure.

That is, according to the related art, even during object recognition by AI, the accuracy of heading angle prediction is not guaranteed. The shape accuracy of the local maxima box derived based on the high object determination confidence within the P-Box cluster may be lower than that of the adjacent boxes eliminated in the NMS process. In addition, tracking system performance may degrade due to jitter in the heading angle estimate for single frame sensor data input. That is, according to the related art, it is difficult to stably track the heading of the same object within consecutive data frames.

To the contrary, according to the exemplary embodiments of the present disclosure, it is possible to improve the prediction accuracy regarding the heading angle of the bounding box predicted by AI through statistical inference using the so-called kernel density estimation scheme. In particular, the scheme of applying Equation 6 described above to obtain the kernel bandwidth is proposed. In the object recognition and heading angle correction system based on an autonomous driving sensor, a probability density function having a heading angle as a probability variable may be derived when calculating the kernel density, and then a heading angle corresponding to the maximum likelihood may be derived.

In addition, through the detailed description of the present disclosure and the attached drawings, those skilled in the art will be able to understand various effects other than the effects described above from the present disclosure.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A system for recognizing an object through an AI module and an autonomous driving sensor and correcting a heading angle, the system comprising:
a processor including an object recognition module, as part of the AI module, that recognizes the object existing in a surrounding environment based on data input from the autonomous driving sensor; and
a memory storing point cloud data,
wherein the AI module is configured to execute:
determining whether to correct the heading angle based on estimation of a kernel density; and
correcting the heading angle for a P-Box predicted by the autonomous driving sensor and the AI module based on that the AI module concludes that correction of the heading angle is necessary as a result of determining whether to correct the heading angle.

2. The system of claim 1, wherein the processor is further configured to execute generating input data for estimating the kernel density based on the P-Box corresponding to local maxima by a non-maximum suppression (NMS) process based on a confidence threshold preset for AI prediction confidence for the P-Box.

3. The system of claim 2, wherein the processor is further configured to execute repeating the determining of whether to correct the heading angle and the correcting of the heading angle until a number of outputs of the NMS process is processed.

4. The system of claim 2, wherein the NMS process is configured to be executed by calculating a maximum point as follows:
$${B}_{1} = {\{ {b}_{1}^{i} \vert {b}_{1}^{i} = [ {c}_{1}^{i} , {s}_{1}^{i} , {x}_{1}^{i} , {y}_{1}^{i} , {z}_{1}^{i} , {l}_{1}^{i} , {w}_{1}^{i} , {h}_{1}^{i} , {θ}_{1}^{i} ] \}}_{i = 1}^{H}$$
$${B}_{2} = {\{ {b}_{2}^{i} \vert {b}_{2}^{i} = [ {c}_{2}^{i} , {s}_{2}^{i} , {x}_{2}^{i} , {y}_{2}^{i} , {z}_{2}^{i} , {l}_{2}^{i} , {w}_{2}^{i} , {h}_{2}^{i} , {θ}_{2}^{i} ] \}}_{i = 1}^{N}$$
$${B}_{3} = {\{ {b}_{3}^{i} \vert {b}_{3}^{i} = [ {c}_{3}^{i} , {s}_{3}^{i} , {x}_{3}^{i} , {y}_{3}^{i} , {z}_{3}^{i} , {l}_{3}^{i} , {w}_{3}^{i} , {h}_{3}^{i} , {θ}_{3}^{i} ] \}}_{i = 1}^{K}$$
wherein B₃ represents the maximum point, bⁱ represents an i-th object P-Box in B₁ which is an output of a deep learning-based object recognition system, c represents a class ID (integer value), B₂ represents an N object P-Boxes of object candidates filtered by the confidence threshold, s represents a prediction score and has a real number where 0<s≤1, (x, y, z) represent a center point position of the object P-Box based on a width, a length and a height of real numbers, (l, w, h) are real numbers representing a width, a length, and a height of a P-Box hexahedron, respectively, and θ is a real number representing a yaw heading angle, and H, N, and K are integers representing a number of object prediction boxes.

5. The system of claim 4, wherein the non-maximum suppression (NMS) process includes additionally outputting index information as follows:
$$M = {\{ {mask}^{i} \vert {mask}^{i} : index information eliminated in NMS process \}}_{i = 1}^{K}$$

6. The system of claim 5, wherein an output result of the correcting of the heading angle is obtained as follows:
$${\hat{B}}_{3} = {\{ {\hat{b}}_{3}^{i} \vert {\hat{b}}_{3}^{i} = [ {c}_{3}^{i} , {s}_{3}^{i} , {x}_{3}^{i} , {y}_{3}^{i} , {z}_{3}^{i} , {l}_{3}^{i} , {w}_{3}^{i} , {h}_{3}^{i} , {\hat{θ}}_{3}^{i} ] \}}_{i = 1}^{K}$$
wherein \hat{B}₃ represents the output result and \hat{θ} is a real number representing the yaw heading angle.

7. The system of claim 1, wherein the determining of whether to correct the heading angle is executed according to a following computer program code:

| | |
|---|---|
| 7: | heading_angle_samples = [ ] |
| 8: | num_samples = 0 |
| 9: | box_heading_angle = box_info[−1] |
| 10: | heading_angle_samples.append(box_heading_angle) |
| 11: | num_samples += 1 |
| 12: | |
| 13: | mask_box_idx_list = mask_box_info[box_idx] |
| 14: | for mask_box_idx in mask_box_idx_list: |
| 15: | mask_box_heading_angle = |
| | nms_before_box_set[mask_box_idx][−1] |
| 16: | heading_angle_smaples.append(mask_box_heading_angle) |
| 17: | num_samples += 1 |

8. The system of claim 1, wherein the determining of whether to correct the heading angle is executed according to a following computer program code:

| | |
|---|---|
| 1: | def check_refinement_necessity(mle_angle, kernel_be, |
| | box_heading_angle): |
| 2: | |
| 3: | reliability_factor = 0.25 |
| 4: | decision_min_boundary = box_heading_angle − |
| | (reliability_factor*kernel_bw) |
| 5: | decision_max_boundary = box_heading_angle + |
| | (reliability_factor*kernel_bw) |
| 6: | if(mle_angle>decision_max_boundary) or |
| | (mle_angle<decision_min_boundary): |
| 7: | return True |
| 8: | else: |
| 9: | return False |

9. The system of claim 1, wherein a kernel bandwidth applied to the determining of whether to correct the heading angle is obtained as follows:
$$Bandwidth = 1.06 \times \hat{σ} \times {n}^{- 0.2}$$
wherein Bandwidth represents the kernel bandwidth, \hat{σ} represents a standard deviation of a data sample set corresponding to a density estimation input, and n represents a number of sample set elements used for density estimation.

10. The system of claim 9, wherein the determining of whether to correct the heading angle includes deriving a heading angle corresponding to a maximum likelihood after deriving a probability density function having the heading angle as a probability variable.

11. A method of recognizing an object through an AI module and an autonomous driving sensor and correcting a heading angle, the method comprising:
determining whether to correct the heading angle based on estimation of a kernel density; and
correcting the heading angle for a P-Box predicted by the autonomous driving sensor and the AI module based on that the AI module concludes that correction of the heading angle is necessary as a result of determining whether to correct the heading angle.

12. The method of claim 11, further comprising:
generating input data for estimating the kernel density based on the P-Box corresponding to local maxima by a non-maximum suppression (NMS) process based on a confidence threshold preset for AI prediction confidence for the P-Box.

13. The method of claim 12, further comprising:
repeating the determining of whether to correct the heading angle and the correcting of the heading angle until a number of outputs of the NMS process is processed.

14. The method of claim 12, wherein the NMS process is configured to be executed by calculating a maximum point as follows:
$${B}_{1} = {\{ {b}_{1}^{i} \vert {b}_{1}^{i} = [ {c}_{1}^{i} , {s}_{1}^{i} , {x}_{1}^{i} , {y}_{1}^{i} , {z}_{1}^{i} , {l}_{1}^{i} , {w}_{1}^{i} , {h}_{1}^{i} , {θ}_{1}^{i} ] \}}_{i = 1}^{H}$$
$${B}_{2} = {\{ {b}_{2}^{i} \vert {b}_{2}^{i} = [ {c}_{2}^{i} , {s}_{2}^{i} , {x}_{2}^{i} , {y}_{2}^{i} , {z}_{2}^{i} , {l}_{2}^{i} , {w}_{2}^{i} , {h}_{2}^{i} , {θ}_{2}^{i} ] \}}_{i = 1}^{N}$$
$${B}_{3} = {\{ {b}_{3}^{i} \vert {b}_{3}^{i} = [ {c}_{3}^{i} , {s}_{3}^{i} , {x}_{3}^{i} , {y}_{3}^{i} , {z}_{3}^{i} , {l}_{3}^{i} , {w}_{3}^{i} , {h}_{3}^{i} , {θ}_{3}^{i} ] \}}_{i = 1}^{K}$$
wherein B₃ represents the maximum point, bⁱ represents an i-th object P-Box in B₁ which is an output of a deep learning-based object recognition system, c represents a class ID (integer value), B₂ represents N object P-Boxes of object candidates filtered by the confidence threshold, s represents a prediction score and has a real number where 0<s≤1, (x, y, z) represent a center point position of the object P-Box based on a width, a length and a height of real numbers, (l, w, h) are real numbers representing a width, a length, and a height of a P-Box hexahedron, respectively, and θ is a real number representing a yaw heading angle, and H, N, and K are integers representing a number of object prediction boxes.

15. The method of claim 14, wherein the non-maximum suppression (NMS) process includes additionally outputting index information as follows:
$$M = {\{ {mask}^{i} \vert {mask}^{i} : index information eliminated in NMS process \}}_{i = 1}^{K} .$$

16. The method of claim 15, wherein an output result of the correcting of the heading angle is obtained as follows:
$${\hat{B}}_{3} = {\{ {\hat{b}}_{3}^{i} \vert {\hat{b}}_{3}^{i} = [ {c}_{3}^{i} , {s}_{3}^{i} , {x}_{3}^{i} , {y}_{3}^{i} , {z}_{3}^{i} , {l}_{3}^{i} , {w}_{3}^{i} , {h}_{3}^{i} , {\hat{θ}}_{3}^{i} ] \}}_{i = 1}^{K}$$
wherein \hat{B}₃ represents the output result and \hat{θ} is a real number representing the yaw heading angle.

17. The method of claim 11, wherein the determining of whether to correct the heading angle is executed according to a following computer program code:

| | |
|---|---|
| 7: | heading_angle_samples = [ ] |
| 8: | num_samples = 0 |
| 9: | box_heading_angle = box_info[−1] |
| 10: | heading_angle_samples.append(box_heading_angle) |
| 11: | num_samples += 1 |
| 12: | |
| 13: | mask_box_idx_list = mask_box_info[box_idx] |
| 14: | for mask_box_idx in mask_box_idx_list: |
| 15: | mask_box_heading_angle = |
| | nms_before_box_set[mask_box_idx][−1] |
| 16: | heading_angle_smaples.append(mask_box_heading_angle) |
| 17: | num_samples += 1 |

18. The method of claim 11, wherein the determining of whether to correct the heading angle is executed according to a following computer program code:

| | |
|---|---|
| 1: | def check_refinement_necessity(mle_angle, kernel_be, |
| | box_heading_angle): |
| 2: | |
| 3: | reliability_factor = 0.25 |
| 4: | decision_min_boundary = box_heading_angle − |
| | (reliability_factor*kernel_bw) |
| 5: | decision_max_boundary = box_heading_angle + |
| | (reliability_factor*kernel_bw) |
| 6: | if(mle_angle>decision_max_boundary) or |
| | (mle_angle<decision_min_boundary): |
| 7: | return True |
| 8: | else: |
| 9: | return False |

19. The method of claim 11, wherein a kernel bandwidth applied to the determining of whether to correct the heading angle is obtained as follows:
$$Bandwidth = 1.06 \times \hat{σ} \times {n}^{- 0.2}$$
wherein Bandwidth represents the kernel bandwidth, \hat{σ} represents a standard deviation of a data sample set corresponding to a density estimation input, and n represents a number of sample set elements used for density estimation.

20. The method of claim 19, wherein the determining of whether to correct the heading angle includes deriving a heading angle corresponding to a maximum likelihood after deriving a probability density function having the heading angle as a probability variable.
